(19) United States
(12) Patent Application Publication
(10) Pub. No.: US 2023/0155841 A1
(43) Pub. Date: May 18, 2023

(54) COMMUNICATION APPARATUSES AND COMMUNICATION METHODS FOR SECURITY IN RESOURCE POOL ALLOCATION

(71) Applicant: Panasonic Intellectual Property Corporation of America, Torrance, CA (US)

(72) Inventors: Tien Ming, Benjamin KOH, Singapore (SG); Chan Wah NG, Singapore (SG); Lei HUANG, Singapore (SG); Akihiko NISHIO, Osaka (JP)

(21) Appl. No.: 17/916,776

(22) PCT Filed: Mar. 23, 2021
(86) PCT No.: PCT/SG2021/050156

§ 371 Date: Oct. 3, 2022

(30) Foreign Application Priority Data
Apr. 7, 2020 (SG) 10202003210T

(51) Int. Cl. H04L 9/32; H04W 12/069; H04W 12/037

(52) U.S. Cl. CPC H04L 9/3263; H04W 12/069; H04W 12/037

(57) ABSTRACT

The present disclosure provides communication apparatuses and communication methods for security in resource pool allocation. The communication apparatuses include a target communication apparatus which comprises a receiver, which in operation, receives a resource information X_{S} from a base station, as well as an authorisation information Xₐᵤₜₕ and an allocated resource R_{S1} from a communication apparatus; and circuitry, which in operation, determines whether or not to utilise the allocated resource R_{S1} based on a verification with the resource information X_{S} and authorisation information Xₐᵤₜₕ.

### TECHNICAL FIELD

The following disclosure relates to communication apparatuses and communication methods for security in resource pool allocation.

### BACKGROUND

Vehicle to everything (V2X) communications avows vehicles to interact with public roads and other road users, and is thus considered a critical factor in making autonomous vehicles a reality.

To accelerate this process, 5^{th} generation (5G) New Radio (NR) based V2X communications (interchangeably referred to as NR V2X communications) is being discussed by the 3rd Generation Partnership Project (3GPP) to identify technical solutions for advanced V2X services, through which vehicles (i.e. interchangeably referred to as communication apparatuses or user equipments (UEs) that support V2X applications) can exchange their own status information through sidelink with other nearby vehicles, infrastructure nodes and/or pedestrians. The status information includes information on position, speed, heading, etc.

The NR V2X communications is expected to complement Cellular V2X communications for the advanced V2X services and support interworking with Cellular V2X communications.

Cellular V2X deployment details largely depend on agreements between regulators, operators and manufacturers (e.g. car original equipment manufacturers (OEMs), automotive ecosystem manufacturers, etc.) and may vary across countries and regions. It is envisioned that:
For basic safety-related V2X services, communications would occur over publicly accessible spectrum (e.g. USA: 5850-5925 MHz).
For specialised services (e.g. HD video/sensor sharing between platoon members), public spectrum may be supplemented with licensed resources obtained from operators.

While resources assigned (which are considered as licensed resources) by base stations of operators are relatively semi-static or slower compared to dynamic requirements of certain advanced V2X scenarios such as collective perception of environment, an operator may be able to grant additional (licensed) resources to a subscriber UE (e.g. a communication apparatus/module of a vehicle that has subscribed to the operator's communication services) that can be further shared with one or more target UEs (e.g. communication apparatuses/modules of one or more vehicles that form a platoon with the subscriber UE or in certain proximity with the subscriber UE). These additional resources may be from resource pools in the operator's licensed spectrum.

However, there has been no discussion so far concerning security in resource allocation of shareable resource pools.

There is thus a need for communication apparatuses and methods that can solve the above mentioned issue. Furthermore, other desirable features and characteristics will become apparent from the subsequent detailed description and the appended claims, taken in conjunction with the accompanying drawings and this background of the disclosure.

### SUMMARY

One non-limiting and exemplary embodiment facilitates security in allocation of resources in 5G NR based V2X communications.

In one aspect, the techniques disclosed herein provide a communication apparatus. For example, the communication apparatus can be a subscriber UE, which may be a communication module integrated or installed in a vehicle subscribed to communication services of a telecommunications operator/public land mobile network (PLMN) operator. The communication apparatus comprises a receiver, which in operation, receives a resource pool R_{S} and a certificate X_{UE} from a base station, the certificate X_{UE} being associated with the resource pool R_{S}; and a transmitter, which in operation, transmits an authorisation information Xₐᵤₜₕ and an allocated resource R_{S1} of the resource pool R_{S} to a target communication apparatus, the authorisation information Xₐᵤₜₕ being derived from the certificate X_{UE}.

In another aspect, the techniques disclosed herein provide a target communication apparatus. For example, the target communication apparatus can be a target UE, which may be a communication module integrated or installed in a vehicle that has a direct connectivity with the subscriber UE or a communication module integrated or installed in a member vehicle within a platoon that the subscribe UE belongs to. In addition to the target UE and the subscribe UE, the platoon may comprise one or more other target UEs. The target communication apparatus comprises a receiver, which in operation, receives a resource information X_{S} from a base station, as well as an authorisation information Xₐᵤₜₕ and an allocated resource R_{S1} from a communication apparatus; and circuitry, which in operation, determines whether or not to utilise the allocated resource R_{S1} based on a verification with the resource information X_{S} and authorisation information Xₐᵤₜₕ.

In yet another aspect, the techniques disclosed herein provide a communication method. The communication method comprises receiving a resource information X_{S} from a base station, as well as an authorisation information Xₐᵤₜₕ and an allocated resource R_{S1} from a communication apparatus; and determining whether or not to utilise the allocated resource R_{S1} based on a verification with the resource information X_{S} and authorisation information Xₐᵤₜₕ.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

Embodiments of the disclosure will be better understood and readily apparent to one of ordinary skilled in the art from the following written description, by way of example only, and in conjunction with the drawings, in which:

FIG. 1 shows an exemplary architecture for a 3GPP NR system.

FIG. 2 is a schematic drawing which shows functional split between NG-RAN and 5GC.

FIG. 3 is a sequence diagram for RRC connection setup/reconfiguration procedures.

FIG. 4 is a schematic drawing showing usage scenarios of Enhanced mobile broadband (eMBB), Massive Machine Type Communications (mMTC) and Ultra Reliable and Low Latency Communications (URLLC).

FIG. 5 is a block diagram showing an exemplary 5G system architecture for a non-roaming scenario.

FIG. 6 shows a schematic example 100 of 5G NR based V2X communications that allows communication apparatuses to allocate and transmit resources to one or more target communication apparatuses.

FIG. 7 shows an example of a distributed denial of service (DDoS) attack on operator resources.

FIG. 8 shows an example of a proximity service (ProSe) relay security procedure.

FIG. 9 shows a signal flow between a base station, a communication apparatus and a target communication apparatus for security in resource pool in accordance with various embodiments.

FIG. 10 shows a signal flow in greater detail between a base station, a communication apparatus and a target communication apparatus for security in resource pool in accordance with various embodiments.

FIG. 11 shows a signal flow between a base station, a communication apparatus and a target communication apparatus for security in resource pool in accordance with an embodiment.

FIG. 12 shows a signal flow between a base station, a communication apparatus and a target communication apparatus for security in resource pool in accordance with an embodiment.

FIG. 13 shows an example of standardisation details that may be adopted for security in resource pool in accordance with various embodiments.

FIG. 14 shows a flow diagram of a communication method for security in resource pool in accordance with various embodiments.

FIG. 15 shows a schematic example of a communication apparatus that can be implemented for security in resource pool in accordance with various embodiments.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DETAILED DESCRIPTION

Some embodiments of the present disclosure will be described, by way of example only, with reference to the drawings. Like reference numerals and characters in the drawings refer to like elements or equivalents.

### 5G NR System Architecture and Protocol Stacks

3GPP has been working at the next release for the 5^{th} generation cellular technology, simply called 5G, including the development of a new radio access technology (NR) operating in frequencies ranging up to 100 GHz. The first version of the 5G standard was completed at the end of 2017, which allows proceeding to 5G NR standard-compliant trials and commercial deployments of smartphones.

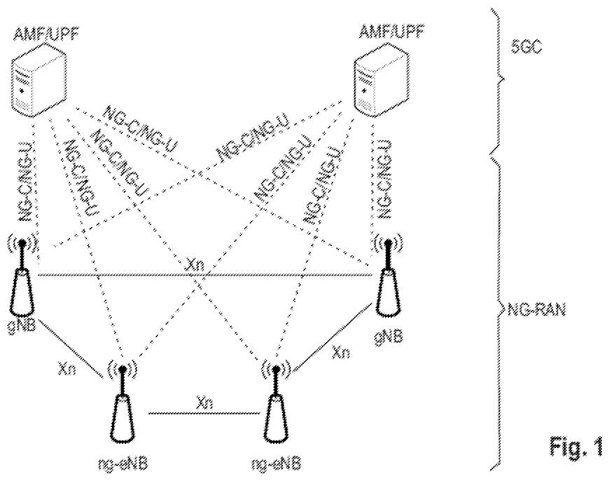

Among other things, the overall system architecture assumes an NG-RAN (Next Generation—Radio Access Network) that comprises gNBs, providing the NG-radio access user plane (SDAP/PDCP/RLC/MAC/PHY) and control plane (RRC) protocol terminations towards the UE. The gNBs are interconnected with each other by means of the Xn interface. The gNBs are also connected by means of the Next Generation (NG) interface to the NGC (Next Generation Core), more specifically to the AMF (Access and Mobility Management Function) (e.g. a particular core entity performing the AMF) by means of the NG-C interface and to the UPF (User Plane Function) (e.g. a particular core entity performing the UPF) by means of the NG-U interface. The NG-RAN architecture is illustrated in FIG. 1 (see e.g. 3GPP TS 38.300 v15.6.0, section 4).

The user plane protocol stack for NR (see e.g. 3GPP TS 38.300, section 4.4.1) comprises the PDCP (Packet Data Convergence Protocol, see section 6.4 of TS 38.300), RLC (Radio Link Control, see section 6.3 of TS 38.300) and MAC (Medium Access Control, see section 6.2 of TS 38.300) sublayers, which are terminated in the gNB on the network side. Additionally, a new access stratum (AS) sublayer (SDAP, Service Data Adaptation Protocol) is introduced above PDCP (see e.g. sub-clause 6.5 of 3GPP TS 38.300). A control plane protocol stack is also defined for NR (see for instance TS 38.300, section 4.4.2). An overview of the Layer 2 functions is given in sub-clause 6 of TS 38.300. The functions of the PDCP, RLC and MAC sublayers are listed respectively in sections 6.4, 6.3, and 6.2 of TS 38.300. The functions of the RRC layer are listed in sub-clause 7 of TS 38.300.

For instance, the Medium-Access-Control layer handles logical-channel multiplexing, and scheduling and scheduling-related functions, including handling of different numerologies.

The physical layer (PHY) is for example responsible for coding, PHY HARQ processing, modulation, multi-antenna processing, and mapping of the signal to the appropriate physical time-frequency resources. It also handles mapping of transport channels to physical channels. The physical layer provides services to the MAC layer in the form of transport channels. A physical channel corresponds to the set of time-frequency resources used for transmission of a particular transport channel, and each transport channel is mapped to a corresponding physical channel. For instance, the physical channels are PRACH (Physical Random Access Channel), PUSCH(Physical Uplink Shared Channel) and PUCCH(Physical Uplink Control Channel) for uplink and PDSCH(Physical Downlink Shared Channel), PDCCH(Physical Downlink Control Channel) and PBCH(Physical Broadcast Channel) for downlink.

Use cases/deployment scenarios for NR could include enhanced mobile broadband (eMBB), ultra-reliable low-latency communications (URLLC), massive machine type communication (mMTC), which have diverse requirements in terms of data rates, latency, and coverage. For example, eMBB is expected to support peak data rates (20 Gbps for downlink and 10 Gbps for uplink) and user-experienced data rates in the order of three times what is offered by IMT-Advanced. On the other hand, in case of URLLC, the tighter requirements are put on ultra-low latency (0.5 ms for UL and DL each for user plane latency) and high reliability (1-10⁻⁵ within 1 ms). Finally, mMTC may preferably require high connection density (1,000,000 devices/km² in an urban environment), large coverage in harsh environments, and extremely long-life battery for low cost devices (15 years).

Therefore, the OFDM numerology (e.g. subcarrier spacing, OFDM symbol duration, cyclic prefix (CP) duration, number of symbols per scheduling interval) that is suitable for one use case might not work well for another. For example, low-latency services may preferably require a shorter symbol duration (and thus larger subcarrier spacing) and/or fewer symbols per scheduling interval (aka, TTI) than an mMTC service. Furthermore, deployment scenarios with large channel delay spreads may preferably require a longer CP duration than scenarios with short delay spreads. The subcarrier spacing should be optimized accordingly to retain the similar CP overhead. NR may support more than one value of subcarrier spacing. Correspondingly, subcarrier spacing of 15 kHz, 30 kHz, 60 kHz . . . are being considered at the moment. The symbol duration Tᵤ and the subcarrier spacing Δf are directly related through the formula Δf=1/Tᵤ. In a similar manner as in LTE systems, the term “resource element” can be used to denote a minimum resource unit being composed of one subcarrier for the length of one OFDM/SC-FDMA symbol.

In the new radio system 5G-NR for each numerology and carrier a resource grid of subcarriers and OFDM symbols is defined respectively for uplink and downlink. Each element in the resource grid is called a resource element and is identified based on the frequency index in the frequency domain and the symbol position in the time domain (see 3GPP TS 38.211 v15.6.0).

(Control Signals)

In the present disclosure, the downlink control signal (information) related to the present disclosure may be a signal (information) transmitted through PDCCH of the physical layer or may be a signal (information) transmitted through a MAC Control Element (CE) of the higher layer or the RRC. The downlink control signal may be a pre-defined signal (information).

The uplink control signal (information) related to the present disclosure may be a signal (information) transmitted through PUCCH of the physical layer or may be a signal (information) transmitted through a MAC CE of the higher layer or the RRC. Further, the uplink control signal may be a pre-defined signal (information). The uplink control signal may be replaced with uplink control information (UCI), the 1st stage sildelink control information (SCI) or the 2nd stage SCI.

(Base Station)

In the present disclosure, the base station may be a Transmission Reception Point (TRP), a clusterhead, an access point, a Remote Radio Head (RRH), an eNodeB (eNB), a gNodeB (gNB), a Base Station (BS), a Base Transceiver Station (BTS), a base unit or a gateway, for example. Further, in side link communication, a terminal may be adopted instead of a base station. The base station may be a relay apparatus that relays communication between a higher node and a terminal. The base station may be a roadside unit as well.

(Uplink/Downlink/Sidelink)

The present disclosure may be applied to any of uplink, downlink and sidelink.

The present disclosure may be applied to, for example, uplink channels, such as PUSCH, PUCCH, and PRACH, downlink channels, such as PDSCH, PDCCH, and PBCH, and side link channels, such as Physical Sidelink Shared Channel (PSSCH), Physical Sidelink Control Channel (PSCCH), and Physical Sidelink Broadcast Channel (PSBCH).

PDCCH, PDSCH, PUSCH, and PUCCH are examples of a downlink control channel, a downlink data channel, an uplink data channel, and an uplink control channel, respectively. PSCCH and PSSCH are examples of a sidelink control channel and a sidelink data channel, respectively. PBCH and PSBCH are examples of broadcast channels, respectively, and PRACH is an example of a random access channel.

(Data Channels/Control Channels)

The present disclosure may be applied to any of data channels and control channels. The channels in the present disclosure may be replaced with data channels including PDSCH, PUSCH and PSSCH and/or control channels including PDCCH, PUCCH, PBCH, PSCCH, and PSBCH.

(Reference Signals)

In the present disclosure, the reference signals are signals known to both a base station and a mobile station and each reference signal may be referred to as a Reference Signal (RS) or sometimes a pilot signal. The reference signal may be any of a Demodulation Reference Signal (DMRS), a Channel State Information—Reference Signal (CSI-RS), a Tracking Reference Signal (TRS), a Phase Tracking Reference Signal (PTRS), a Cell-specific Reference Signal (CRS), and a Sounding Reference Signal (SRS).

(Time Intervals)

In the present disclosure, time resource units are not limited to one or a combination of slots and symbols, and may be time resource units, such as frames, superframes, subframes, slots, time slot subslots, minislots, or time resource units, such as symbols, Orthogonal Frequency Division Multiplexing (OFDM) symbols, Single Carrier-Frequency Division Multiplexing Access (SC-FDMA) symbols, or other time resource units. The number of symbols included in one slot is not limited to any number of symbols exemplified in the embodiment(s) described above, and may be other numbers of symbols.

(Frequency Bands)

The present disclosure may be applied to any of a licensed band and an unlicensed band.

(Communication)

The present disclosure may be applied to any of communication between a base station and a terminal (Uu-link communication), communication between a terminal and a terminal (Sidelink communication), and Vehicle to Everything (V2X) communication. The channels in the present disclosure may be replaced with PSCCH, PSSCH, Physical Sidelink Feedback Channel (PSFCH), PSBCH, PDCCH, PUCCH, PDSCH, PUSCH, and PBCH.

In addition, the present disclosure may be applied to any of a terrestrial network or a network other than a terrestrial network (NTN: Non-Terrestrial Network) using a satellite or a High Altitude Pseudo Satellite (HAPS). In addition, the present disclosure may be applied to a network having a large cell size, and a terrestrial network with a large delay compared with a symbol length or a slot length, such as an ultra-wideband transmission network.

(Antenna Ports)

An antenna port refers to a logical antenna (antenna group) formed of one or more physical antenna(s). That is, the antenna port does not necessarily refer to one physical antenna and sometimes refers to an array antenna formed of multiple antennas or the like. For example, it is not defined how many physical antennas form the antenna port, and instead, the antenna port is defined as the minimum unit through which a terminal is allowed to transmit a reference signal. The antenna port may also be defined as the minimum unit for multiplication of a precoding vector weighting.

### 5G NR Functional Split Between NG-RAN and 5GC

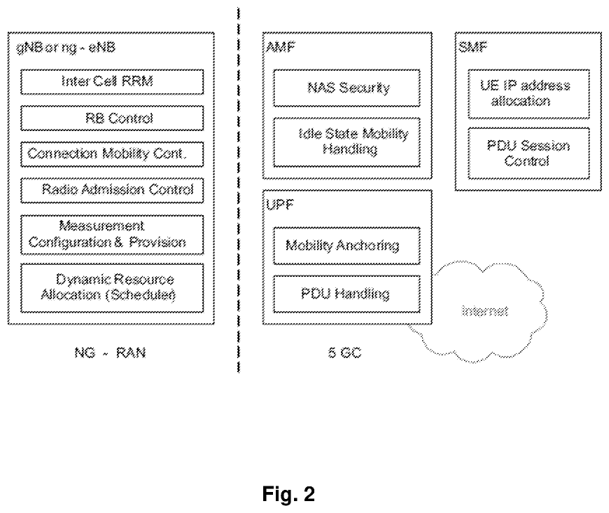

FIG. 2 illustrates functional split between NG-RAN and 5GC. NG-RAN logical node is a gNB or ng-eNB. The 5GC has logical nodes AMF, UPF and SMF.

In particular, the gNB and ng-eNB host the following main functions:
Functions for Radio Resource Management such as Radio Bearer Control, Radio Admission Control, Connection Mobility Control, Dynamic allocation of resources to UEs in both uplink and downlink (scheduling);
IP header compression, encryption and integrity protection of data;
Selection of an AMF at UE attachment when no routing to an AMF can be determined from the information provided by the UE;
Routing of User Plane data towards UPF(s);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA.
   The Access and Mobility Management Function (AMF) hosts the following main functions:
Non-Access Stratum, NAS, signalling termination;
NAS signalling security;
Access Stratum, AS, Security control;
Inter Core Network, CN, node signalling for mobility between 3GPP access networks;
Idle mode UE Reachability (including control and execution of paging retransmission);
Registration Area management;
Support of intra-system and inter-system mobility;
Access Authentication;
Access Authorization including check of roaming rights;
Mobility management control (subscription and policies);
Support of Network Slicing;
Session Management Function, SMF, selection.
   Furthermore, the User Plane Function, UPF, hosts the following main functions:
Anchor point for Intra-/Inter-RAT mobility (when applicable);
External PDU session point of interconnect to Data Network;
Packet routing & forwarding;
Packet inspection and User plane part of Policy rule enforcement;
Traffic usage reporting;
Uplink classifier to support routing traffic flows to a data network;
Branching point to support multi-homed PDU session;
QoS handling for user plane, e.g. packet filtering, gating, UL/DL rate enforcement;
Uplink Traffic verification (SDF to QoS flow mapping);
Downlink packet buffering and downlink data notification triggering.
   Finally, the Session Management function, SMF, hosts the following main functions:
Session Management;
UE IP address allocation and management;
Selection and control of UP function;
Configures traffic steering at User Plane Function, UPF, to route traffic to proper destination;
Control part of policy enforcement and QoS;
Downlink Data Notification.

### RRC Connection Setup and Reconfiguration Procedures

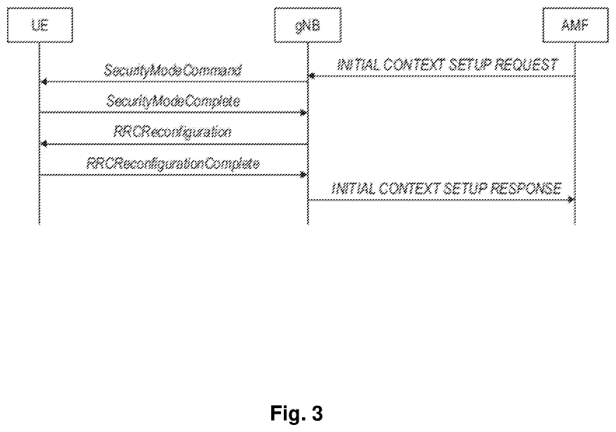

FIG. 3 illustrates some interactions between a UE, gNB, and AMF (an 5GC entity) in the context of a transition of the UE from RRC_IDLE to RRC_CONNECTED for the NAS part (see TS 38.300 v15.6.0). RRC is a higher layer signaling (protocol) used for UE and gNB configuration. In particular, this transition involves that the AMF prepares the UE context data (including e.g. PDU session context, the Security Key, UE Radio Capability and UE Security Capabilities, etc.) and sends it to the gNB with the INITIAL CONTEXT SETUP REQUEST. Then, the gNB activates the AS security with the UE, which is performed by the gNB transmitting to the UE a SecurityModeCommand message and by the UE responding to the gNB with the SecurityModeComplete message. Afterwards, the gNB performs the reconfiguration to setup the Signaling Radio Bearer 2, SRB2, and Data Radio Bearer(s), DRB(s) by means of transmitting to the UE the RRCReconfiguration message and, in response, receiving by the gNB the RRCReconfigurationComplete from the UE. For a signalling-only connection, the steps relating to the RRCReconfiguration are skipped since SRB2 and DRBs are not setup. Finally, the gNB informs the AMF that the setup procedure is completed with the INITIAL CONTEXT SETUP RESPONSE.

In the present disclosure, thus, an entity (for example AMF, SMF, etc.) of a 5th Generation Core (5GC) is provided that comprises control circuitry which, in operation, establishes a Next Generation (NG) connection with a gNodeB, and a transmitter which, in operation, transmits an initial context setup message, via the NG connection, to the gNodeB to cause a signaling radio bearer setup between the gNodeB and a user equipment (UE). In particular, the gNodeB transmits a Radio Resource Control, RRC, signaling containing a resource allocation configuration information element to the UE via the signaling radio bearer. The UE then performs an uplink transmission or a downlink reception based on the resource allocation configuration.

### Usage Scenarios of IMT for 2020 and Beyond

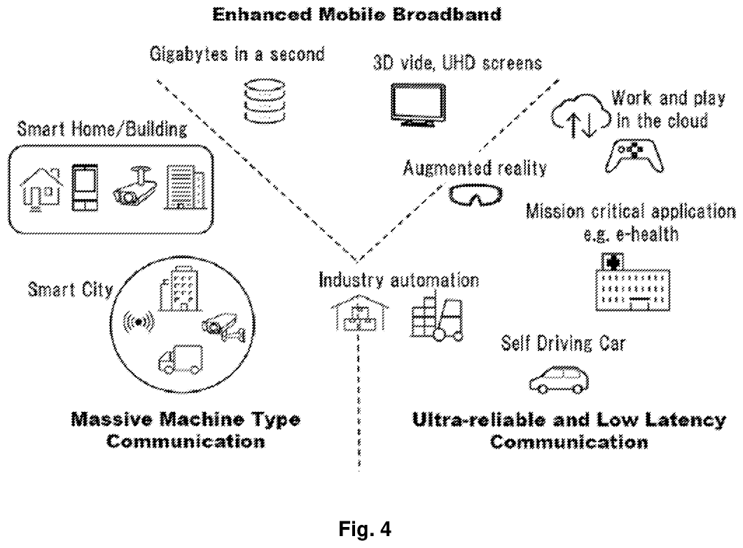

FIG. 4 illustrates some of the use cases for 5G NR. In 3rd generation partnership project new radio (3GPP NR), three use cases are being considered that have been envisaged to support a wide variety of services and applications by IMT-2020. The specification for the phase 1 of enhanced mobile-broadband (eMBB) has been concluded. In addition to further extending the eMBB support, the current and future work would involve the standardization for ultra-reliable and low-latency communications (URLLC) and massive machine-type communications. FIG. 4 illustrates some examples of envisioned usage scenarios for IMT for 2020 and beyond (see e.g. ITU-R M.2083 FIG. 2).

The URLLC use case has stringent requirements for capabilities such as throughput, latency and availability and has been envisioned as one of the enablers for future vertical applications such as wireless control of industrial manufacturing or production processes, remote medical surgery, distribution automation in a smart grid, transportation safety, etc. Ultra-reliability for URLLC is to be supported by identifying the techniques to meet the requirements set by TR 38.913. For NR URLLC in Release 15, key requirements include a target user plane latency of 0.5 ms for UL (uplink) and 0.5 ms for DL (downlink). The general URLLC requirement for one transmission of a packet is a BLER (block error rate) of 1E-5 for a packet size of 32 bytes with a user plane latency of 1 ms.

From the physical layer perspective, reliability can be improved in a number of possible ways. The current scope for improving the reliability involves defining separate CQI tables for URLLC, more compact DCI formats, repetition of PDCCH, etc. However, the scope may widen for achieving ultra-reliability as the NR becomes more stable and developed (for NR URLLC key requirements). Particular use cases of NR URLLC in Rel. 15 include Augmented RealityNirtual Reality (AR/VR), e-health, e-safety, and mission-critical applications.

Moreover, technology enhancements targeted by NR URLLC aim at latency improvement and reliability improvement. Technology enhancements for latency improvement include configurable numerology, non slot-based scheduling with flexible mapping, grant free (configured grant) uplink, slot-level repetition for data channels, and downlink pre-emption. Pre-emption means that a transmission for which resources have already been allocated is stopped, and the already allocated resources are used for another transmission that has been requested later, but has lower latency/higher priority requirements. Accordingly, the already granted transmission is pre-empted by a later transmission. Pre-emption is applicable independent of the particular service type. For example, a transmission for a service-type A (URLLC) may be pre-empted by a transmission for a service type B (such as eMBB). Technology enhancements with respect to reliability improvement include dedicated CQI/MCS tables for the target BLER of 1E-5.

The use case of mMTC (massive machine type communication) is characterized by a very large number of connected devices typically transmitting a relatively low volume of non-delay sensitive data. Devices are required to be low cost and to have a very long battery life. From NR perspective, utilizing very narrow bandwidth parts is one possible solution to have power saving from UE perspective and enable long battery life.

As mentioned above, it is expected that the scope of reliability in NR becomes wider. One key requirement to all the cases, and especially necessary for URLLC and mMTC, is high reliability or ultra-reliability. Several mechanisms can be considered to improve the reliability from radio perspective and network perspective. In general, there are a few key potential areas that can help improve the reliability. Among these areas are compact control channel information, data/control channel repetition, and diversity with respect to frequency, time and/or the spatial domain. These areas are applicable to reliability in general, regardless of particular communication scenarios.

For NR URLLC, further use cases with tighter requirements have been identified such as factory automation, transport industry and electrical power distribution, including factory automation, transport industry, and electrical power distribution. The tighter requirements are higher reliability (up to 10⁻⁶ level), higher availability, packet sizes of up to 256 bytes, time synchronization down to the order of a few ps where the value can be one or a few ps depending on frequency range and short latency in the order of 0.5 to 1 ms in particular a target user plane latency of 0.5 ms, depending on the use cases.

Moreover, for NR URLLC, several technology enhancements from the physical layer perspective have been identified. Among these are PDCCH (Physical Downlink Control Channel) enhancements related to compact DCI, PDCCH repetition, increased PDCCH monitoring. Moreover, UCI (Uplink Control Information) enhancements are related to enhanced HARQ (Hybrid Automatic Repeat Request) and CSI feedback enhancements. Also PUSCH enhancements related to mini-slot level hopping and retransmission/repetition enhancements have been identified. The term “mini-slot” refers to a Transmission Time Interval (TTI) including a smaller number of symbols than a slot (a slot comprising fourteen symbols).

### QoS Control

The 5G QoS (Quality of Service) model is based on QoS flows and supports both QoS flows that require guaranteed flow bit rate (GBR QoS flows) and QoS flows that do not require guaranteed flow bit rate (non-GBR QoS Flows). At NAS level, the QoS flow is thus the finest granularity of QoS differentiation in a PDU session. A QoS flow is identified within a PDU session by a QoS flow ID (QFI) carried in an encapsulation header over NG-U interface.

For each UE, 5GC establishes one or more PDU Sessions. For each UE, the NG-RAN establishes at least one Data Radio Bearers (DRB) together with the PDU Session, and additional DRB(s) for QoS flow(s) of that PDU session can be subsequently configured (it is up to NG-RAN when to do so), e.g. as shown above with reference to FIG. 3. The NG-RAN maps packets belonging to different PDU sessions to different DRBs. NAS level packet filters in the UE and in the 5GC associate UL and DL packets with QoS Flows, whereas AS-level mapping rules in the UE and in the NG-RAN associate UL and DL QoS Flows with DRBs.

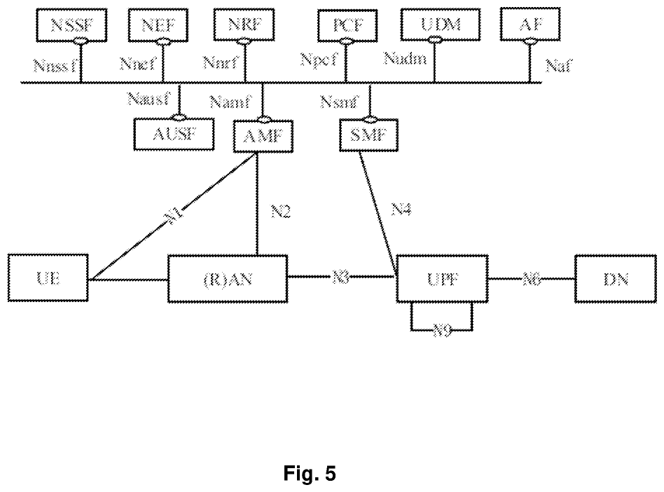

FIG. 5 illustrates a 5G NR non-roaming reference architecture (see TS 23.501 v16.1.0, section 4.23). An Application Function (AF), e.g. an external application server hosting 5G services, exemplarily described in FIG. 4, interacts with the 3GPP Core Network in order to provide services, for example to support application influence on traffic routing, accessing Network Exposure Function (NEF) or interacting with the Policy framework for policy control (see Policy Control Function, PCF), e.g. QoS control. Based on operator deployment, Application Functions considered to be trusted by the operator can be allowed to interact directly with relevant Network Functions. Application Functions not allowed by the operator to access directly the Network Functions use the external exposure framework via the NEF to interact with relevant Network Functions.

FIG. 5 shows further functional units of the 5G architecture, namely Network Slice Selection Function (NSSF), Network Repository Function (NRF), Unified Data Management (UDM), Authentication Server Function (AUSF), Access and Mobility Management Function (AMF), Session Management Function (SMF), and Data Network (DN), e.g. operator services, Internet access or 3rd party services. All of or a part of the core network functions and the application services may be deployed and running on cloud computing environments.

In the present disclosure, thus, an application server (for example, AF of the 5G architecture), is provided that comprises a transmitter, which, in operation, transmits a request containing a QoS requirement for at least one of URLLC, eMMB and mMTC services to at least one of functions (for example NEF, AMF, SMF, PCF, UPF, etc) of the 5GC to establish a PDU session including a radio bearer between a gNodeB and a UE in accordance with the QoS requirement and control circuitry, which, in operation, performs the services using the established PDU session.

NR V2X communications is designed to complement Cellular V2X communications for advanced V2X services, which are categorised into four groups: vehicles platooning, extended sensors, advanced driving and remote driving.

Vehicles platooning enables vehicles to dynamically form a platoon travelling together. All the vehicles in the platoon obtain information from a leading vehicle to manage this platoon. Such information allows the vehicles to drive closer than normal in a coordinated manner, going to the same direction and travelling together.

Extended sensors enables the exchange of raw or processed data gathered through local sensors or live video images among vehicles, road site units (RSUs), devices of pedestrian and V2X application servers. The vehicles can increase the perception of their environment beyond of what their own sensors can detect and have a more broad and holistic view of the local situation.

Advanced driving enables semi-automated or full-automated driving. Each vehicle and/or RSU shares its own perception data obtained from its local sensors with vehicles in proximity and that allows vehicles to synchronize and coordinate their trajectories or manoeuvres. Each vehicle shares its driving intention with vehicles in proximity too.

Remote driving enables a remote driver or a V2X application to operate a remote vehicle for those passengers who cannot drive by themselves or remote vehicles located in dangerous environments. For a case where variation is limited and routes are predictable, such as public transportation, driving based on cloud computing can be used.

In the above described advanced V2X services, for example, in a vehicles platooning service, the communication between the member vehicles of the platoon is rather private and thus requires private communication resources that are dedicated for the platooning. Private communication resources are usually assigned by telecommunication operators/public land mobile network (PLMN) operators as per requests by the subscribers, at cost. Out of cost-saving consideration, in various cases, only the leading vehicle of the platoon requests for the private communication resources and shares the private communication resources with its fellow member vehicles in the platoon.

In known V2X communication techniques, the private communication resources are assigned by the telecommunication/PLMN operators with indication of permitted users being the member vehicles in the platoon at the time of the leading vehicle requesting for the private communication resources.

It is possible that as the journey continues, one or more member vehicles in the platoon may reach their destinations and exit the platoon while one or more new member vehicles joining to the platoon. In such scenarios, the previously assigned private communication resources have vacant resources that could be used by the new member vehicles. However, due to the static indication of permitted users, the leading vehicle is not able to sub-allocate and transmit those vacant resources with the new member vehicles.

Similarly, in an extended sensors service, a vehicle may need to obtain sensor data from different road site units one at a time, e.g. traffic lights of the respective next intersections. In the known V2X communication techniques, due to the static indication of permitted users, the private communication resources previously assigned to the vehicle when it is approaching traffic light A of Intersection A cannot be sub-allocated and transmitted by the vehicle to traffic light B when it later approaches Intersection B.

In the following paragraphs, certain exemplifying embodiments are explained with reference to a NR V2X communications mechanism between a communication apparatus (i.e. a UE) and one or more target communication apparatuses (i.e. T-UEs) that allows the communication apparatus to sub-allocate and transmit licensed resources to one or more target communication apparatuses. For the sake of simplicity, the private communication resources assigned by the telecommunication/PLMN operators may be interchangeably referred to as resources, dedicated resources or licensed resources in the present disclosure.

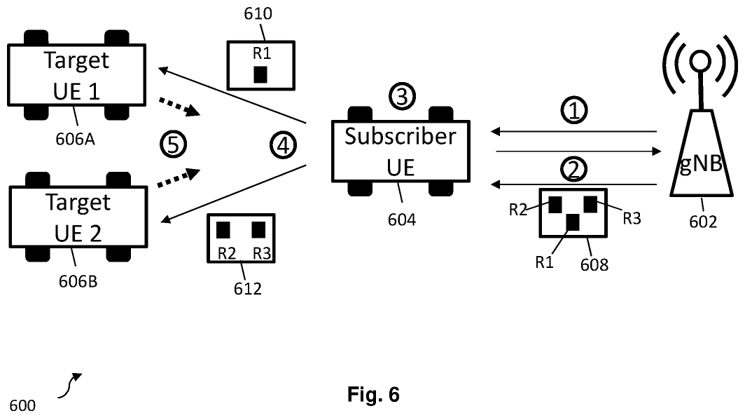

FIG. 6 depicts a schematic example 600 of a 5G NR based V2X communication that allows communication apparatuses to allocate and transmit resources to a plurality of target communication apparatuses. In this example, a NR V2X communications mechanism between a communication apparatus and one or more target communication apparatuses allows the communication apparatus to sub-allocate and transmit resources to one or more target communication apparatuses. For the sake of simplicity, the private communication resources assigned by the telecommunication/PLMN operators may be interchangeably referred to as resources, dedicated resources, licensed resources or resource pool in the present disclosure.

As described above, the communication apparatuses may be interchangeably referred to as subscriber UEs. The subscriber UEs include communication modules integrated or installed in vehicles subscribed to communication services of one or more telecommunications/PLMN operators. For the sake of simplicity, the schematic example 600 as shown in FIG. 6 includes one subscriber UE/communication apparatus 604.

In the schematic example 600, the communication apparatus 604 is subscribed to a telecommunication/PLMN operator operator (not shown) and communicates with a base station 602 of the telecommunication operator. In the present example, the base station 602 is a next generation NodeB (gNB) 602. The base station 602 can also be a ng-eNB, which is a node providing Evolved Universal Mobile Telecommunications System (UMTS) Terrestrial Radio Access (E-UTRA) user plane and control plane protocol terminations towards the communication apparatus 604, and connected via the NG interface to the 5G core network.

In various embodiments, the communication apparatus 604 includes a receiver, which in operation, receives information of a first resource from the base station 602, as shown in step 2 of FIG. 6. For the sake of simplicity, the receiver is not shown in FIG. 6. The information of the first resource may be interchangeably referred to as the first resource information. The first resource information indicates a first resource 608 allocated by the base station 602. In some examples, the first resource 608 includes one or more carrier frequencies/frequency bands (e.g. R1, R2 and R3 as shown in FIG. 6) allocated to the communication apparatus 604. In some other examples, multiple resources may be defined within a single carrier. Therefore, public/common resources and private resources may exist within different time-frequency resources of the same carrier. As such, in an alternative embodiment, the first resource 608 includes one or more time-frequency resources of a carrier allocated to the communication apparatus 604.

The one or more carrier frequencies/frequency bands or one or more time-frequency resources of a carrier allocated to the communication apparatus 604 are dedicated for V2X communications with target communication apparatuses. Such a V2X communication may be considered as a V2X sidelink communication.

The first resource 608 is different from a resource directly allocated to a target communication apparatus or a plurality of target communication apparatuses by the base station 602. In addition, the first resource 608 that includes one or more carrier frequencies/frequency bands or one or more time-frequency resources of a carrier dedicated to the communication apparatus 604 for V2X communications with target communication apparatuses may be considered as a private resource pool. Likewise, the base station 602 may define a public/common resource that include certain carrier frequencies/frequency bands or certain time-frequency resources of the same carrier as the first resource 608, which may be considered as a public/common resource pool. In some embodiments, some information elements/fields in the first resource information may be configured to control how the communication apparatus 604 can utilise the first resource 608.

In various embodiments, the communication apparatus 604 also includes a transmitter, which in operation, transmits to a target communication apparatus or a plurality of target communication apparatuses information of a second resource indicating a second resource allocated to at least the target communication apparatus, as shown in step 4 of FIG. 6. The plurality of target communication apparatuses include the target communication apparatus. The second resource includes a whole or a part of the first resource. For the sake of simplicity, the transmitter is not shown in FIG. 6, and the information of the second resource indicating may be interchangeably referred to as the second resource information.

In some examples, as shown in step 1 of FIG. 6, prior to receiving the first resource information from the base station 602 as shown in step 2 of FIG. 6, the communication apparatus 604 may acquire system information blocks (SIBs) broadcast by the base station 602, especially system information block type 21 (SIB 21) and/or system information block type 26 (SIB 26) that define carrier frequency information for V2X sidelink communications; and transmit its sidelinkUEinformation (SL-UEInfo) to the base station 602 so as to request allocation of the first resource 608 from the base station. It is appreciable to the skilled person that a new system information block type may be defined by the 3GPP for NR V2X communications. Alternatively or additionally, when such a new SIB is defined, the communication apparatus 604 may also acquire the new SIBs from the base station 602 in step 1. In some embodiments, the sidelinkUEinformation may include information relating to a plurality of target communication apparatuses so that the base station 602 may assign resources appropriately. In some other embodiments, the sidelinkUEinformation may not include the information relating to the plurality of target communication apparatuses, so that the subsequent allocation of second resources by the communication apparatus 604 may be more dynamic and flexible.

In some examples, the transmission of the second resource as shown in step 4 of FIG. 6 may be initiated by the communication apparatus 604 autonomously and dynamically sub-allocating the first resource 608 as a second resource 610, 612 to one or more target communication apparatuses, as shown in step 3 of FIG. 6.

In some other examples, the transmission of the second resource as shown in step 4 of FIG. 6 may be initiated by the communication apparatus 604 in response to a request received from a server (not shown) of a V2X service application that requires the communication apparatus 604 to communicate with the target communication apparatuses 606A for an one time transfer and/or to communicate with the target communication apparatuses 606B for periodic updates regarding the V2X service in question, as shown in step 3 of FIG. 6.

As described above, a target communication apparatus may be interchangeably referred to as a target UE, or T-UE. A target communication apparatus can be a communication module integrated or installed in a vehicle that has a direct connectivity with the communication apparatus 604. Such a direct connectivity is considered a unicast level connection between the target communication apparatus and the communication apparatus 604.

Alternatively, a target communication apparatus can be a communication module integrated or installed in a member vehicle of a platoon that the communication apparatus 604 belongs to. For example, the communication apparatus 604 may form a platoon with a plurality of target communication apparatuses. In the platoon, the communication apparatus 604 may not have a unicast level connection with the respective individual target communication apparatuses, but instead have a group level connection with all the target communication apparatuses to the platoon.

In some embodiments, the communication apparatus 604 may be connected to a target communication apparatus 606A via a unicast level connection. The unicast level connection may be a sidelink-based Access Stratum (AS) level connection that exists independently of existing RRC connections between the base station 602 and the communication apparatus 604 or the target communication apparatus 606A.

In some alternative embodiments, as shown in FIG. 6, the communication apparatus 604 may be connected to a plurality of target communication apparatuses that include the target communication apparatus 606A and another target communication apparatus 606B. The communication apparatus 604, the target communication apparatus 606A, and the other target communication apparatus 606B may form a platoon and interconnected via a groupcast level connection. For example, the groupcast level connection may be dependent on an existing connection to a group/cluster head vehicle (e.g. the communication apparatus 604) or alternatively based on some metric depending upon the presence of other group members. The groupcast level connection may be a sidelink-based Access Stratum (AS) level connection that exists independently of existing RRC connections between the base station 602 and the communication apparatus 604, the target communication apparatus 606A or the other target communication apparatus 606B.

It is appreciable to those skilled in the art that, in other embodiments, the two target communication apparatuses 606A, 606B may each have a unicast level connection with the communication apparatus 604. In addition to the target communication apparatus 606A and the other target communication apparatus 606B, the platoon may comprise more group members (i.e. target communication apparatuses) that are not shown in FIG. 6.

In some embodiments, the communication apparatus 604 is connected to the target communication apparatus 606A via a unicast level connection. As such, there is a presence of an AS level connection between the communication apparatus 604 and the target communication apparatus 606A. In these embodiments, the communication apparatus 604 may allocate a part (e.g. R1) of the first resource 608 as a second resource 610 to the target communication apparatus 606A, as shown in step 3 of FIG. 6 and transmit information of the second resource 610 to the target communication apparatus 606A, as shown in step 4 of FIG. 6. From the perspective of the target communication apparatus 606A, at step 4 of FIG. 6, the target communication apparatus 606A receives the information of the second resource 610 from the communication apparatus 604. Alternatively, the second resource 610 may include all (e.g. R1, R2, R3) of the first resource 608. Once the information of the second resource 610 is successfully received by the target communication apparatus 606A, the second resource 610 may be used to establish a V2X communication between the communication apparatus 604 and the target communication apparatus 606A. For example, from the perspective of the communication apparatus 604, the communication apparatus 604 may utilise the second resource 610 to transmit a first signal (not shown) to the target communication apparatus 606A, and receive a second signal from the target communication apparatus 606A as shown in step 5 of FIG. 6, such that a V2X sidelink communication is established between the communication apparatus 604 and the target communication apparatus 606A for advanced V2X services. From the perspective of the target communication apparatus 606A, the target communication apparatus 606A may utilise the second resource 610 to receive the first signal from the communication apparatus 604, and transmit the second signal to the communication apparatus 604 as shown in step 5 of FIG. 6, such that a V2X sidelink communication is established between the communication apparatus 604 and the target communication apparatus 606A for advanced V2X services.

In some other embodiments, the communication apparatus 604 is connected to a plurality of target communication apparatuses that include the target communication apparatus 606A and the other target communication apparatus 606B via a groupcast level connection. As such, there is a presence of an AS level connection between the communication apparatus 604 and the plurality of target communication apparatuses. In these embodiments, the communication apparatus 604 and the plurality of target communication apparatuses may form a platoon.

In some examples, the communication apparatus 604 may allocate a whole (e.g. R1, R2, R3) or a part (e.g. R2, R3) of the first resource 608 as a second resource 612 to the target communication apparatus 606A and the other target communication apparatus 606B of the plurality of target communication apparatuses, and transmit information of the second resource 612 to the target communication apparatus 606A and the other target communication apparatus 606B. In this manner, the target communication apparatus 606A and the other target communication apparatus 606B may use the same second resource 612 for V2X communications with the communication apparatus 604, with each other, and/or with other target communication apparatuses in the platoon in a similar manner as described above with respect to the unicast level connection.

In some examples, the communication apparatus 604 may allocate different parts (R1; R2, R3) of the first resource 608 as different second resources 610, 612 to the target communication apparatus 606A and the other target communication apparatus 606B, respectively; and transmit information of the different second resources 610, 612 to the target communication apparatus 606A and the other target communication apparatus 606B respectively, as shown in step 4 of FIG. 6. In this manner, the target communication apparatus 606A and the other target communication apparatus 606B may use respective second resources 610, 612 for V2X communications with the communication apparatus 604, with each other, and/or with other target communication apparatuses in the platoon in a similar manner as described above with respect to the unicast level connection.

In the above examples, when transmitting the second resource(s) 610, 612 to the target communication apparatus 606A and the other target communication apparatus 606B, the communication apparatus 604 may indicate in information of a second resource that which entities in the platoon are allowed to use the second resource(s) 610, 612 for transmitting and/or receiving signals. For the sake of simplicity, the information of the second resource may be interchangeably referred to as the second resource information. For example, the second resource information may be indicated in a second resource information element. The second resource information element may include one or more fields/elements that indicate a list of target apparatus IDs that are allowed to transmit signals using the second resource(s) 610, 612 for V2X communications, a list of target apparatus IDs that are allowed to receive signals using the second resource(s) 610, 612 for V2X communications, an expiry timer that defines a time limit for each of the list of target apparatus IDs to use the second resource(s) 610, 612 each time, etc. In some embodiments, the expiry timer may be predetermined by the base station 602 and indicated in the second resource information element by the communication apparatus 604. In some embodiments, the expiry timer may be determined by the communication apparatus 604 and indicated in the second resource information element by the communication apparatus 604. In some other embodiments, the expiry timer may be predetermined by the base station 602 and broadcast to and known by all the connected communication apparatus and target communication apparatus in the system information blocks.

By virtue of the above dynamic allocation of the second source(s), the utilisation of the second source(s) is advantageously optimized. As a measure to ensure low latency and high reliability for V2X communications, it may be further advantageous to define in the second resource information element that all the target communication apparatuses in the platoon can use the second resource(s) 610, 612 for V2X communications as long as the target communication apparatus in question has an AS level connection with the platoon or is within a certain proximity with the communication apparatus 604. In this manner, any new member vehicles joining into the platoon and meeting the above requirements may be able to utilise the second resource(s) for V2X communications without requiring the communication apparatus 104 to request for new resources from the base station 602. Such an arrangement improves the flexibility of NR sidelink framework and allows easy extension of a NR system to support future developments of further advanced V2X services and other services.

In some embodiments, the second resource information element may include an indication of requiring an AS level connection as a prerequisite for allocation and transmission of resources. Such an arrangement may further lower latency and enhance reliability of the NR system. For example, when an AS level connection between the communication apparatus 604 with the target communication apparatus 606A, the other target communication apparatus 606B or the plurality of target communication apparatuses is lost, the communication apparatus 604 may withdraw the second resource allocated to the respective target communication apparatus or the plurality of target communication apparatuses. Likewise, the target communication apparatus 606A, the other target communication apparatus 606B or the plurality of target communication apparatuses may delete the respective second resource from available resources.

When there are more than one communication apparatus/subscriber UE providing resources for V2X communications in the platoon, it is also convenient and advantageous for a target target communication apparatus in the platoon to choose which resource to use based on the one or more fields/elements indicated in the respective second resource information elements being transmitted by the different communication apparatuses/subscriber UEs. In other words, the one or more fields/elements facilitate the target communication apparatus to choose the second resource from a plurality of available resources for data transmission in V2X communications.

The receiver of the communication apparatus 604 may receive the first resource information from the base station 602 via a dedicated signaling. For example, the dedicated signaling may include a radio resource control (RRC) signaling, such as a RRCReconfiguration message including sl-V2X-ConfigDedicated with additional information elements contained within the RRCReconfiguration message that indicate that the mentioned resource is dedicated to the communication apparatus 604 and maybe further shared.

Likewise, the transmitter of the communication apparatus 604 may transmit the second resource information to the target communication apparatus 606A, the other target communication apparatus 606B, and/or the plurality of target communication apparatuses via another dedicated signaling. For example, the other dedicated signaling may include a RRC signaling, a physical downlink control channel (PDCCH) signaling, or an application specific signaling (e.g. a car camera streaming application carries information about radio resources that can be used by another vehicles within a certain proximity or by other vehicles in a platoon).

In summary, the example of FIG. 6 describes the method of a configurable, shareable resource pool that is initially configured by the gNB and allocated to a UE (referred to as Subscriber UE, or S-UE). The S-UE can then dynamically configure and/or allocate a subset of the assigned resources in this private pool to other UEs (referred to as Target UEs, or T-UEs). However, the T-UEs have no way to verify the authority of S-UE to allocate resource pools owned by network operators. This can result in security issues such as distributed denial of service (DDoS) attack on operator resources.

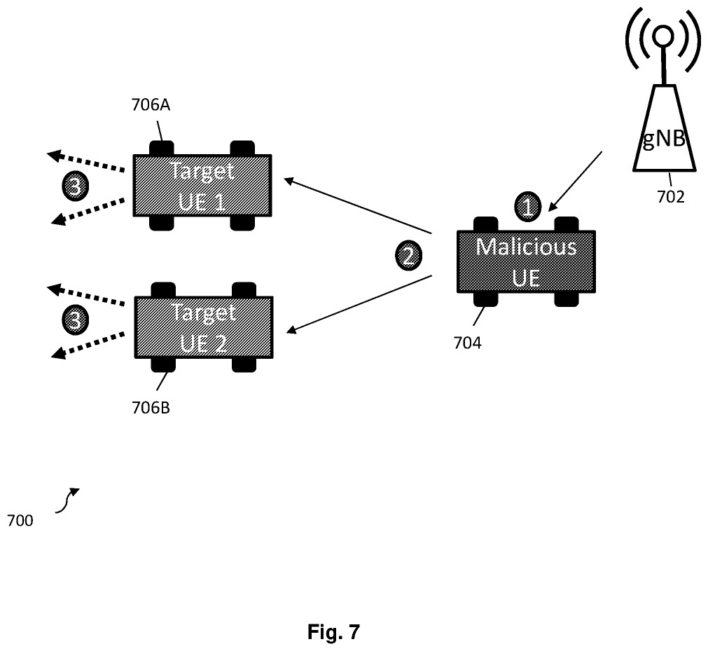

FIG. 7 shows an example of such a DDoS attack on resources similar to the resource pool described in FIG. 6. At step 1, a malicious UE 704 listens to SIBs broadcasted by a gNB 702 to know which are the resource pools in the operator's licensed spectrum. At step 2, the malicious UE 704 sends fake sidelink control messages to allocate resources from operator's resource pool to T-UE1 706A and T-UE2 706B. At step 3, T-UE1 706A and T-UE2 706B unknowingly contributes to the DDoS attack on the operator's resource pools, due to a lack of ability to verify whether the malicious UE has the authority to allocate resources from the operator's resource pool.

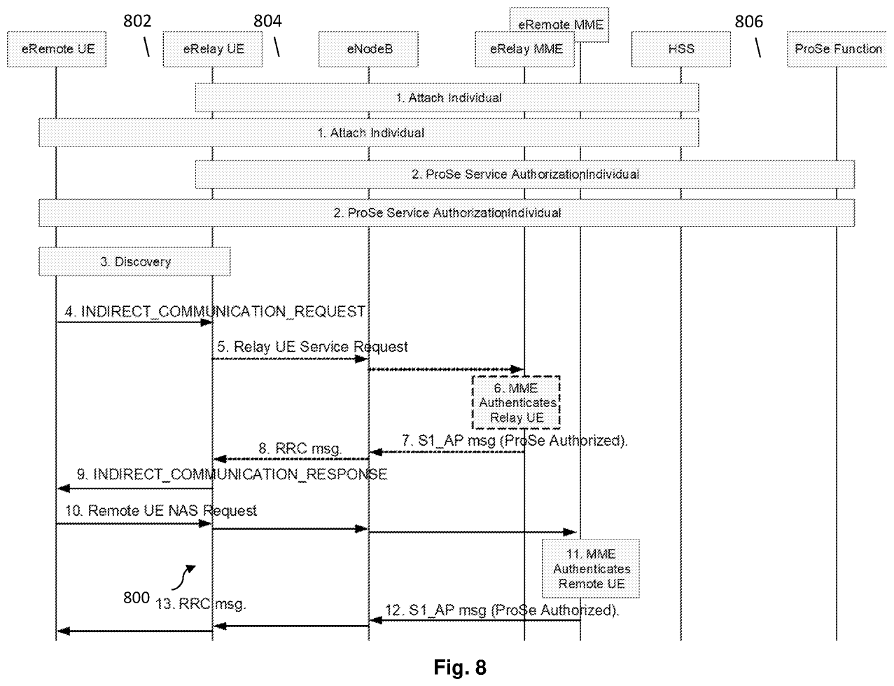

A procedure for verifying authority of a UE to allocate resources is shown in FIG. 8. This procedure utilises proximity service (ProSe) relay security function. Specifically, eRelay-UE 802 and eRemote-UE 804 performs service authorisation at step 2 with the ProSe Function 806 using legacy procedures (TS23.303). The ProSe Function 806 will furthermore explicitly provide permission as well as specific information used to decrypt a restricted discovery message in step 3.

In step 2, the eRemote UE 802 receives Relay UE information (Discovery Group IDs, Relay Service Codes, and associated with the ProSe Key Management Function address) from its Home PLMN (HPLMN) ProSe Function 806. These shall be used to fetch security parameters for discovery. These parameters may also be pre-configured into the eRemote UE 802. The eRemote UE 802 then sends a Key Request message to a ProSe Key Management Function (PKMF) including relevant Relay Service Codes or the Discovery Group ID that it wishes to get security material for. The eRemote-UE 802 and eRelay-UE 804 then perform PC5 discovery procedure in step 3, using obtained parameters in Step 2.

The example as shown in FIG. 8, however, requires the eRemote UE 802 and eRelay UE 804 to be connected to a core network and utilises the ProSe Function and PKMF to authorize both Relay and Remote UE before discovery.

Therefore, the present disclosure provides a security solution for verifying authority of a UE to allocate resources as well as without the restrictions mentioned above.

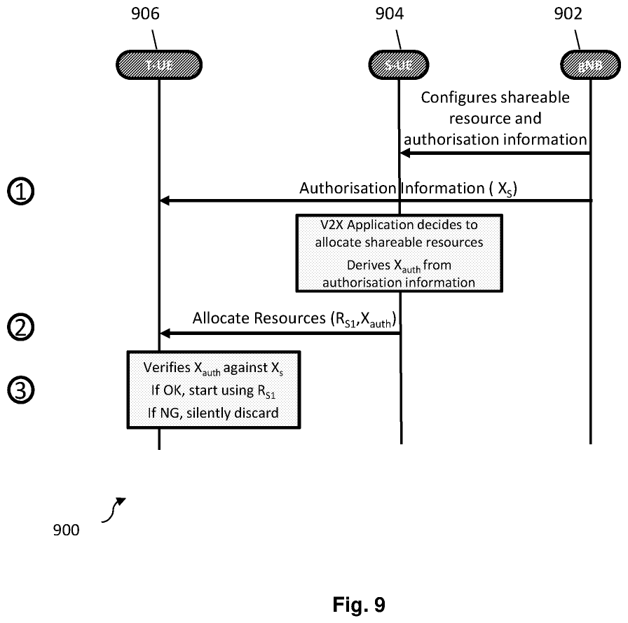

FIG. 9 shows a signal flow 900 between a base station 902 (or gNB 902), a communication apparatus 904 (or S-UE 904) and a target communication apparatus 906 (or T-UE 906) for security in resource pool in accordance with various embodiments. This figure illustrates a high level concept of the present solution, wherein the main idea revolves around having a receiving UE (i.e. T-UE 906) to verify that a gNB (i.e. gNB 902) has authorised the use of resources provided by a sending UE (i.e. S-UE 904). This is primarily achieved by comparing a first piece of information received from gNB to a second piece of information by the sending UE.

For example, at step 1, T-UE 906 receives resource information (X_{S}) from gNB 902. When T-UE 906 receives the allocated resources (R_{S1}) from S-UE 904 at step 2, it also receives authorisation information (Xₐᵤₜₕ). T-UE 906 then performs an additional step of verification by using X_{S} and Xₐᵤₜₕ to verify if S-UE is indeed authorized to allocate resources R_{S1}. Possible verification methods include utilising existing cryptographic functions to relate Xₐᵤₜₕ, X_{S}, and R_{S1}. If the verification confirms that S-UE 904 is authorized, the T-UE can then utilise the resource allocated by the S-UE 404 for transmission. Otherwise, the resource is discarded. Advantageously, such a verification process can prevent DDoS attacks such as shown in FIG. 7.

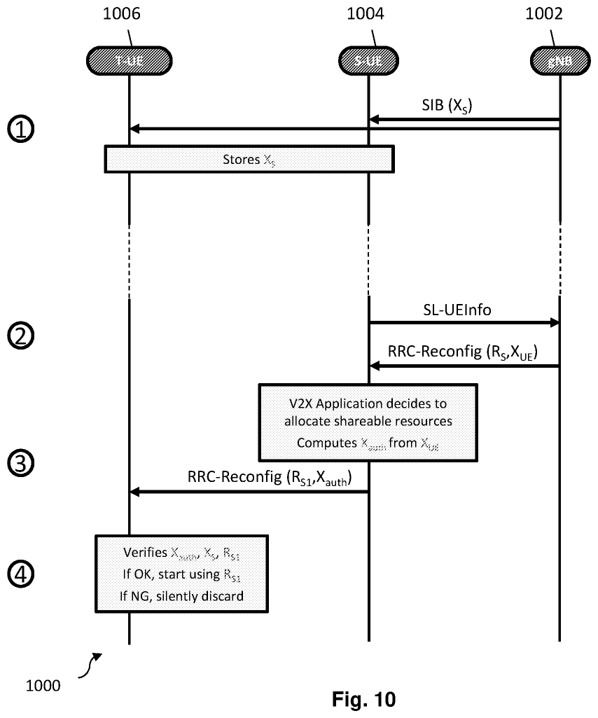

FIG. 10 shows signal flow 1000 in greater detail between a base station 1002 (or gNB 1002), a communication apparatus 1004 (or S-UE 1004) and a target communication apparatus 1006 (or T-UE 1006) for security in resource pool in accordance with various embodiments. At step 1, the gNB 1002 associates resource information (referred to as X_{S}) with a dedicated shareable resource pool. This resource information X_{S} may be broadcasted via SIBs, such that the information is sent to all V2X-capable UEs (including the S-UE 1004 and the T-UE 1006). The resource information X_{S} may not literally be in all broadcasted SIBs, but in SIBs that are included in RRC-Reconfiguration messages send to each UE. The resource information X_{S} is then received by the S-UE 5104 and the T-UE 1006 through their respective receivers, and stored in their respective memory.

In step 2, the S-UE 1004 transmits its SL-UEInfo to the gNB 1002 so as to request allocation of resource from the base station. The gNB 1002 responds to the SL-UEInfo by transmitting to the S-UE 1004 a RRC signaling (such as a RRCReconfiguration (RRC-Reconfig) message) with information indicating a shareable resource pool R_{S} and a certificate X_{UE} associated with the resource pool R_{S}. Further, the resource information X_{S} should be related to the certificate X_{UE}.

In step 3, V2X application of the S-UE 1004 decides to allocate shareable resources to the T-UE 1006. The S-UE 1004 computes authorisation information Xₐᵤₜₕ from X_{UE} and transmits, via its transmitter, the authorisation information Xₐᵤₜₕ and information indicating an allocated resource R_{S1}. The R_{S1} is a subset of the R_{S}. The information may be transmitted via a RRC-Reconfig message. The T-UE 1006 receives the authorisation information Xₐᵤₜₕ and information indicating an allocated resource R_{S1} via its receiver and, in step 4, determines whether or not to utilise the allocated resource R_{S1} for transmission based on a verification with the resource information X_{S} and authorisation information Xₐᵤₜₕ.

The verification is to confirm whether the S-UE 1004 has the authority to allocate the resource R_{S}, and is done by computing a pre-determined function f(Xₐᵤₜₕ) X_{S}, R_{S1}). How X_{S}, R_{S} (or R_{S1} which is a subset of R_{S}), X_{UE} and Xₐᵤₜₕ are related can be of numerous variations. In a simple case:
X_{S}=information of shareable resources (frequency bands, subframe-numbers)
X_{UE}=Xₐᵤₜₕ=empty
Then the function f( ) will simply be a check if the allocated resource R_{S1} falls within X_{S}
   Other variations are also possible, as will be further illustrated below.

In a first variation of the verification process, the concept lies in that the gNB authorise S-UE but not the specific resources i.e. the R_{S1}. In this case, the gNB may simply broadcast a X_{S}=digest(X_{UE}) to all UEs including the S-UE and T-UE, wherein digest(m) is a cryptographic digest/checksum of an octet string m such as using MD5 or SHA. The S-UE then uses Xₐᵤₜₕ=X_{UE} when allocating part of R_{S} (i.e. R_{S1}). Therefore, the verification of f( ) is simply checking if digest(Xₐᵤₜₕ)=X_{S}.

In a second variation of the verification process, the concept lies in that the gNB authorises S-UE for a set of resources (R_{S}) and sends [checksum, resource set] pairs to allow T-UE to verify:
gNB broadcasts a list of {R_{S},X_{S}}ᵢ pairs, wherein X_{S}=digest(R_{S}.fields|K_{S}) for a specific K_{S}, “R_{S}.fields” being the concatenation of some pre-determined fields of the SL-CommResourcePoolV2X object describing R_{S} (e.g. sl-OffsetIndicator-r14|sl-Subframe-r14|sizeSubchannel-r14 startRB-Subchannel-r14) and “|” being the concatenation operator
When gNB configures S-UE with one R_{S}, it also includes the associated Ks (i.e. X_{UE}=K_{S})
When S-UE allocates R_{S1} (part of R_{S}) to T-UE, it uses Xₐᵤₜₕ={X_{UE},R_{S}}
T-UE must then verify that:
   a. R_{S1} is part of R_{S}; and
   b. digest(R_{S}.fields|X_{UE}) is the same as the broadcasted X_{S} associated with R_{S}

In a third variation of the verification process, the concept lies in that the gNB authorises S-UE for a set of resources (R_{S}) and sends public key that allows T-UE to verify the set of resources sent by S-UE:
gNB broadcasts a X_{S}=some public key K_{pub} of a asymmetric key-pair {K_{pub},Kₚᵣᵥ}, Kₚᵣᵥ being a private key
When the gNB configures S-UE with one R_{S}, it also includes a certificate as X_{UE} where X_{UE}=enc(digest(R_{S}.fields),Kₚᵣᵥ), enc(m,k) being an encryption of an octet string m using key k
When S-UE allocates R_{S1} (part of R_{S}) to T-UE, it uses Xₐᵤₜₕ={X_{UE},R_{S}}
T-UE must then verify that:
   a. R_{S1} is part of R_{S}; and
   b. dec(X_{UE},X_{S})=digest(R_{S}.fields), dec(m,k) being a decryption of an octet string m using key k

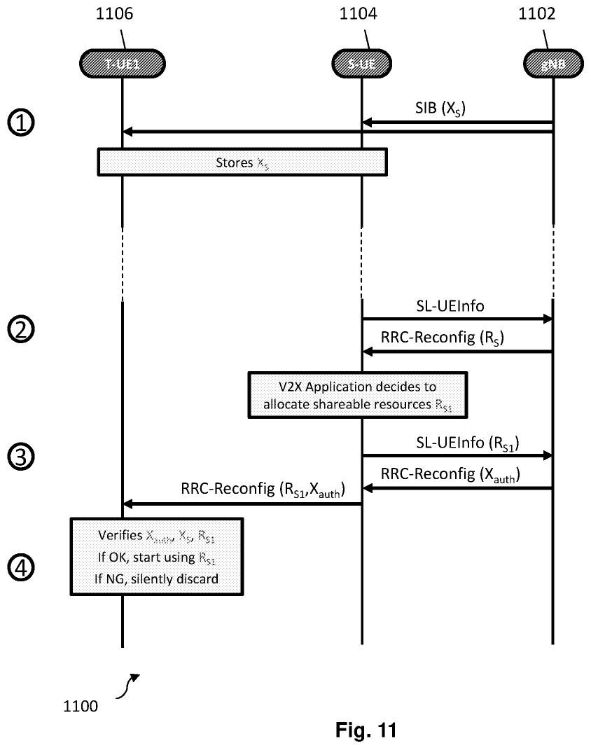

In another variation of the verification process, the concept is similar to that of the third variation as described above but T-UE does not need to verify that the provided resource is a subset of the authorized set of resources. FIG. 11 shows a signal flow between a base station (gNB 1102), a communication apparatus (S-UE 1104) and a target communication apparatus (T-UE 1106) in accordance with said variation of the verification process:
In step 1, gNB 1102 broadcasts a X_{S}=some public key K_{pub} of a asymmetric key-pair {K_{pub},Kₚᵣᵥ}
After being assigned a R_{S} in step 2, whenever the S-UE 1104 desires to allocate a R_{S1} (part of R_{S}) to T-UE 1106, it will ask the gNB 1102 for a certificate of R_{S1} i.e. in step 3
gNB 1102 returns with Xₐᵤₜₕ=enc(digest(R_{S1}.fields),Kₚᵣᵥ), and S-UE 1104 sends sidelink RRC-Reconfiguration to T-UE 1102 with Xₐᵤₜₕ,R_{S1}
In step 4, T-UE 1102 verifies that dec(Xₐᵤₜₕ,X_{S})=digest(R_{S1}.fields)

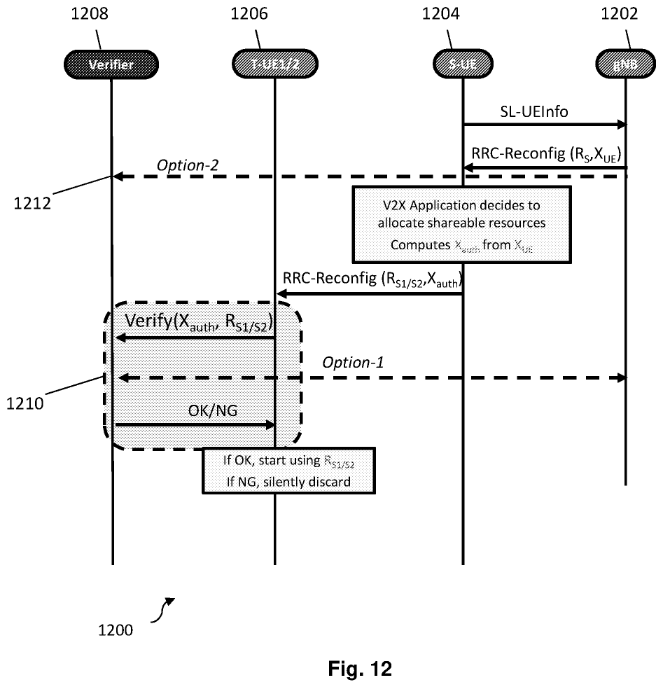

In yet another variation, the verification procedure is logically separated from the T-UE and may be performed by a different/external entity. FIG. 12 shows a signal flow between a base station (gNB 1202), a communication apparatus S-UE 1204, target communication apparatuses T-UE1 1206A and T-UE2 1206B, and a verifier 1208 in accordance with said variation of the verification process.

The verifier 1208 is a trusted entity that will verify on behalf of T-UEs 1206A and 1206B whether S-UE 1204 is authorized to allocate resources from R_{S}. i.e. R_{S1} allocation for T-UE 1206A and R_{S2} allocation for T-UE 1206B. The verifier 1208 may be a network entity in the PLMN of T-UEs 1206A and 1206B (which may not be the same PLMN as gNB 1202 or S-UE 1204) and may possess V2X/ProSe application functions. Communications set up between the T-UEs and the verifier 1208 is assumed to be carried out independently.

The verifier 1208 may perform the verification in several ways. In an example, at step 1210, the verifier 1208 may query the gNB 1202 (or some network entity in the PLMN of gNB 1202) to check if the holder of Xₐᵤₜₕ has the authority for R_{S1/S2}. The verifier may then cache the result for some time period and notify the verification result to the T-UEs 1206A and 1206B within said time period. In another example, in step 1212, the gNB 1202 (or some network entity in PLMN of gNB 1202) may explicitly inform the verifier 1208 how to verify, such as providing a list of R_{S} and X_{UE/auth} to the verifier 1208. It will be appreciated that “how to verify” may encompass some of the calculation methods described in the earlier variations above, except that the calculations here are performed by the verifier 1208 instead of the T-UEs 1206A and 1206B, with the advantage that some information need not be broadcasted to all UEs but only to the verifier 1208, thus freeing up more resources in the resource pool.

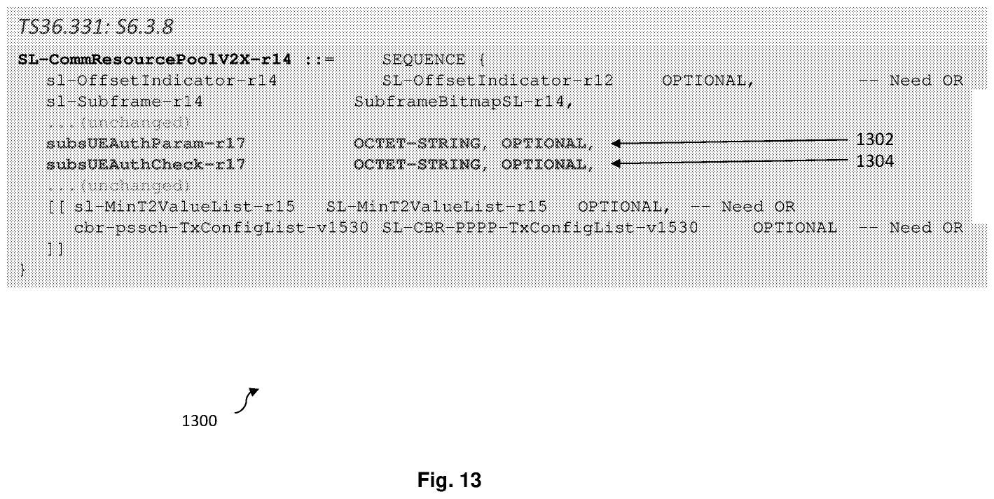

FIG. 13 shows an example of standardisation details that may be adopted for security in resource pool in accordance with various embodiments as discussed above. gNB may specify X_{UE} in the new subsUEAuthParam-r17 field (see line 1302) included in the SL-V2X-ConfigDedicated-r14.commsTxResources-r14.v2x-SchedulingPool-r16 or SL-V2X-ConfigDedicated-r14.commsTxResources-r14.v2x-sharedPool-r16 ^{[1]} object in the RRC-Reconfiguration message to S-UE. On the other hand, S-UE may specify Xₐᵤₜₕ in the new subsUEAuthCheck-r17 field (see line 1304) included in the SL-V2X-ConfigDedicated-r14.commsTxResources-r14.v2x-SchedulingPool-r16 or SL-V2X-ConfigDedicated-r14.commsTxResources-r14.v2x-sharedPool-r16 object in the RRC-Reconfiguration message to the T-UEs.

It will be appreciated that the formulation of X_{S}, X_{UE}, Xₐᵤₜₕ and f( ) may include some timing elements (e.g. radio-frame number) to restrict the authority of S-UE to a limited time period.

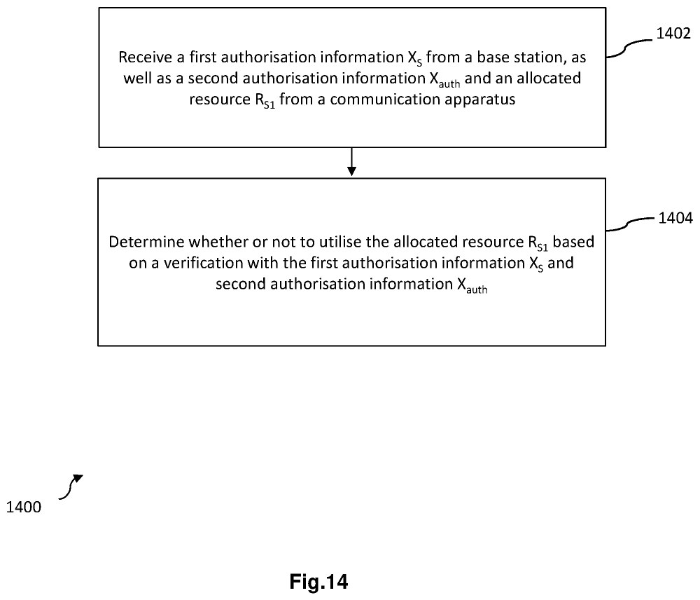

FIG. 14 shows a flow diagram 1400 illustrating a communication method according to various embodiments. In step 1402, a resource information X_{S} from a base station, as well as an authorisation information Xₐᵤₜₕ and an allocated resource R_{S1} from a communication apparatus are received. In step 1404, it is determined whether or not to utilise the allocated resource R_{S1} based on a verification with the resource information X_{S} and authorisation information Xₐᵤₜₕ.

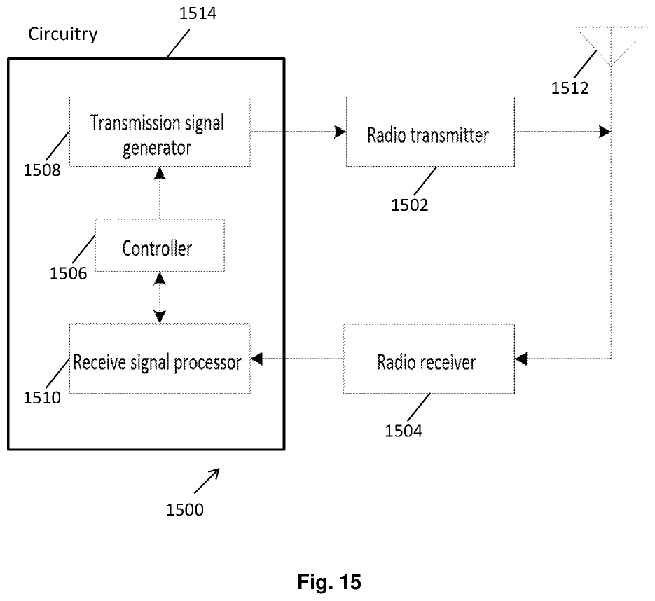

FIG. 15 shows a schematic, partially sectioned view of the communication apparatus 1500 that can be implemented for security in resource pool in accordance with various embodiments as shown in FIGS. 1 to 14. The communication apparatus 1500 may be implemented as a gNB, S-UE or T-UE according to various embodiments.

Various functions and operations of the communication apparatus 1500 are arranged into layers in accordance with a hierarchical model. In the model, lower layers report to higher layers and receive instructions therefrom in accordance with 3GPP specifications. For the sake of simplicity, details of the hierarchical model are not discussed in the present disclosure.

As shown in FIG. 15, the communication apparatus 1500 may include circuitry 1514, at least one radio transmitter 1502, at least one radio receiver 1504 and multiple antennas 1512 (for the sake of simplicity, only one antenna is depicted in FIG. 15 for illustration purposes). The circuitry may include at least one controller 1506 for use in software and hardware aided execution of tasks it is designed to perform, including control of communications with one or more other communication apparatuses in a MIMO wireless network. The at least one controller 1506 may control at least one transmission signal generator 1508 for generating SIB, SL-UEInfo and/or RRC-Reconfig messages to be sent through the at least one radio transmitter 1502 to one or more other communication apparatuses and at least one receive signal processor 1510 for processing said SIB, SL-UEInfo and/or RRC-Reconfig messages received through the at least one radio receiver 1504 from the one or more other communication apparatuses. The at least one transmission signal generator 1508 and the at least one receive signal processor 1510 may be stand-alone modules of the communication apparatus 1500 that communicate with the at least one controller 1506 for the above-mentioned functions, as shown in FIG. 15. Alternatively, the at least one transmission signal generator 1508 and the at least one receive signal processor 1510 may be included in the at least one controller 1506. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 1502, at least one radio receiver 1504, and at least one antenna 1512 may be controlled by the at least one controller 1506.

In the embodiment shown in FIG. 15, the at least one radio receiver 1504, together with the at least one receive signal processor 1510, forms a receiver of the communication apparatus 1500. The receiver of the communication apparatus 1500, when in operation, provides functions required for facilitating security in resource pool allocation.

The communication apparatus 1500, when in operation, provides functions required for facilitating security in resource pool allocation. For example, the communication apparatus 1500 may be a communication apparatus, and the receiver 1504 may, in operation, receive a resource pool R_{S} and a certificate X_{UE} from a base station, the certificate X_{UE} being associated with the resource pool R_{S}. The transmitter 1502 may, in operation, transmit an authorisation information Xₐᵤₜₕ and an allocated resource R_{S1} of the resource pool R_{S} to a target communication apparatus, the authorisation information Xₐᵤₜₕ being derived from the certificate X_{UE}.

The transmitter 1502 may be further configured to transmit a sidelinkUEinformation to the base station prior to receiving, at the receiver, the resource pool R_{S} and certificate X_{UE} from the base station. The receiver 1504 may be further configured to receive a resource information X_{S} from the base station via a broadcast.

The receiver 1504 may be further configured to receive a resource information X_{S}=digest(X_{UE}) from the base station, “digest(m)” being a cryptographic digest/checksum of octet string m; wherein the transmitter 1502 is further configured to transmit the authorisation information Xₐᵤₜₕ=X_{UE} to the target communication apparatus; and wherein a verification whether the communication apparatus is authorised to allocate resources from the resource pool R_{S} comprises checking if digest(Xₐᵤₜₕ)=X_{S}.

The receiver 1504 may be further configured to receive a list of {R_{S},X_{S}}ᵢ pairs from the base station, wherein resource information X_{S}=digest(R_{S}.fields|K_{S}) for a specific K_{S}, “digest(m)” being a cryptographic digest/checksum of octet string m, “R_{S}.fields” being a concatenation of one or more pre-determined fields of SL-CommResourcePoolV2X object describing R_{S}, and “|” being a concatenation operator; wherein XᵤE=K_{S} and Xₐᵤₜₕ={X_{UE},R_{S}}; and wherein a verification whether the communication apparatus is authorised to allocate resources from the resource pool R_{S} comprises determining whether R_{S1} is part of R_{S} and whether digest(R_{S}.fields|X_{UE}) is the same as the resource information X_{S} that is associated with resource pool R_{S}.

The receiver 1504 may be further configured to receive X_{S} from the base station, wherein X_{S} is a public key K_{pub} of a asymmetric key-pair {K_{pub},Kₚᵣᵥ}, Kₚᵣᵥ being a private key; wherein X_{UE}=enc(digest(R_{S}.fields),Kₚᵣᵥ), “digest(m)” being a cryptographic digest/checksum of octet string m and “enc(m,k)” being an encryption of an octet string m using key k; wherein Xₐᵤₜₕ={X_{UE},R_{S}}; and wherein a verification whether the communication apparatus is authorised to allocate resources from the resource pool R_{S} comprises determining whether R_{S1} is part of R_{S} and whether dec(X_{UE},X_{S})=digest(R_{S}.fields), “dec(m,k)” being a decryption of an octet string m using key k and “R_{S}.fields” being a concatenation of one or more pre-determined fields of SL-CommResourcePoolV2X object describing resource pool R_{S}.

The receiver 1504 may be further configured to receive X_{S} from the base station, wherein X_{S} is a public key K_{pub} of a asymmetric key-pair {K_{pub},Kₚᵣᵥ}, Kₚᵣᵥ being a private key; wherein Xₐᵤₜₕ32 enc(digest(R_{S}.fields),Kₚᵣᵥ), “digest(m)” being a cryptographic digest/checksum of octet string m and “enc(m,k)” being an encryption of an octet string m using key k; and wherein a verification whether the communication apparatus is authorised to allocate resources from the resource pool R_{S} comprises determining whether dec(Xₐᵤₜₕ,X_{S})=digest(R_{S}.fields), “dec(m,k)” being a decryption of an octet string m using key k and “R_{S}.fields” being a concatenation of one or more pre-determined fields of SL-CommResourcePoolV2X object describing R_{S}.

The communication apparatus 1500, when in operation, provides functions required for facilitating security in resource pool allocation. For example, the communication apparatus 1500 may be a target communication apparatus, and the receiver 1504 may, in operation, receive a resource information X_{S} from a base station, as well as an authorisation information Xₐᵤₜₕ and an allocated resource R_{S1} from a communication apparatus. The circuitry 1514 may, in operation, determine whether or not to utilise the allocated resource R_{S1} based on a verification with the resource information X_{S} and authorisation information Xₐᵤₜₕ.

The receiver 1504 may be further configured to receive the resource information X_{S} from the base station via a broadcast.

The receiver 1504 may be configured to receive the resource information X_{S}=digest(X_{UE}) from the base station, “digest(m)” being a cryptographic digest/checksum of octet string m; wherein the receiver 1504 may be further configured to receive the authorisation information Xₐᵤₜₕ=X_{UE} from the communication apparatus; and wherein the verification comprises checking if digest(Xₐᵤₜₕ)=X_{S}.

The receiver 1504 may be further configured to receive a list of {R_{S},X_{S}}ᵢ pairs from the base station, “R_{S}” being a resource pool of the allocated resource R_{S1}, wherein X_{S}=digest(R_{S}.fields|K_{S}) for a specific K_{S}, “digest(m)” being a cryptographic digest/checksum of octet string m, “R_{S}.fields” being a concatenation of one or more pre-determined fields of SL-CommResourcePoolV2X object describing R_{S}, and “|” being the concatenation operator; wherein X_{UE}=K_{S} and Xₐᵤₜₕ={X_{UE},R_{S}}; and wherein the verification comprises determining whether R_{S1} is part of R_{S} and whether digest(R_{S}.fields|X_{UE}) is the same as the broadcasted X_{S}.

The receiver 1504 may be further configured to receive X_{S} from the base station, wherein X_{S} is a public key K_{pub} of a asymmetric key-pair {K_{pub},Kₚᵣᵥ}, Kₚᵣᵥ being a private key; wherein X_{UE}=enc(digest(R_{S}.fields),Kₚᵣᵥ), “digest(m)” being a cryptographic digest/checksum of octet string m, “enc(m,k)” being an encryption of an octet string m using key k and “R_{S}.fields” being a concatenation of one or more pre-determined fields of SL-CommResourcePoolV2X object describing resource pool R_{S} of the allocated resource R_{S1;} wherein Xₐᵤₜₕ={X_{UE},R_{S}}; and wherein the verification comprises determining whether R_{S1} is part of R_{S} and whether dec(X_{UE},X_{S})=digest(R_{S}.fields), “dec(m,k)” being a decryption of an octet string m using key k.

The receiver 1504 may be further configured to receive the resource information X_{S} from the base station, wherein X_{S} is a public key K_{pub} of a asymmetric key-pair {K_{pub},Kₚᵣᵥ}, Kₚᵣᵥ being a private key; wherein Xₐᵤₜₕ=enc(digest(R_{S}.fields),Kₚᵣᵥ), “digest(m)” being a cryptographic digest/checksum of octet string m, “enc(m,k)” being an encryption of an octet string m using key k and “R_{S}.fields” being a concatenation of one or more pre-determined fields of SL-CommResourcePoolV2X object describing resource pool R_{S} of the allocated resource R_{S1}; and wherein the verification comprises determining whether dec(Xₐᵤₜₕ,X_{S})=digest(R_{S}.fields), “dec(m,k)” being a decryption of an octet string m using key k.

The circuitry 1514 may be further configured to perform the verification, or wherein the verification is performed by an external entity.

As described above, the embodiments of the present disclosure provides advanced communication methods and communication apparatuses that enables security in allocation of resources by communication apparatuses/subscriber UEs.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication apparatus.

The communication apparatus may comprise a transceiver and processing/control circuitry. The transceiver may comprise and/or function as a receiver and a transmitter. The transceiver, as the transmitter and receiver, may include an RF (radio frequency) module including amplifiers, RF modulators/demodulators and the like, and one or more antennas.

Some non-limiting examples of such communication apparatus include a phone (e.g, cellular (cell) phone, smart phone), a tablet, a personal computer (PC) (e.g, laptop, desktop, netbook), a camera (e.g, digital still/video camera), a digital player (digital audio/video player), a wearable device (e.g, wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication apparatus is not limited to be portable or movable, and may also include any kind of apparatus, device or system being non-portable or stationary, such as a smart home device (e.g, an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication apparatus may comprise a device such as a controller or a sensor which is coupled to a communication device performing a function of communication described in the present disclosure. For example, the communication apparatus may comprise a controller or a sensor that generates control signals or data signals which are used by a communication device performing a communication function of the communication apparatus.

The communication apparatus also may include an infrastructure facility, such as a base station, an access point, and any other apparatus, device or system that communicates with or controls apparatuses such as those in the above non-limiting examples.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects illustrative and not restrictive.

1. A communication apparatus, comprising:
a receiver, which in operation, receives a resource pool R_{S} and a certificate X_{UE} from a base station, the certificate X_{UE} being associated with the resource pool R_{S}; and
a transmitter, which in operation, transmits an authorisation information Xₐᵤₜₕ and an allocated resource R_{S1} of the resource pool R_{S} to a target communication apparatus, the authorisation information Xₐᵤₜₕ being derived from the certificate X_{UE}.

2. The communication apparatus according to claim 1, wherein the transmitter is further configured to transmit a sidelinkUEinformation to the base station prior to receiving, at the receiver, the resource pool R_{S} and certificate X_{UE} from the base station.

3. The communication apparatus according to claim 1, wherein the receiver is configured to receive a resource information X_{S} from the base station via a broadcast.

4. The communication apparatus according to claim 1, wherein the receiver is configured to receive a resource information X_{S}=digest(X_{UE}) from the base station, “digest(m)” being a cryptographic digest/checksum of octet string m;
wherein the transmitter is configured to transmit the authorisation information Xₐᵤₜₕ=X_{UE} to the target communication apparatus; and
wherein a verification whether the communication apparatus is authorised to allocate resources from the resource pool R_{S} comprises checking if digest(Xₐᵤₜₕ)=X_{S}.

5. The communication apparatus according to claim 1, wherein the receiver is configured to receive a list of {R_{S},X_{S}}ᵢ pairs from the base station, wherein resource information X_{S}=digest(R_{S}.fields|K_{S}) for a specific K_{S}, “digest(m)” being a cryptographic digest/checksum of octet string m, “R_{S}.fields” being a concatenation of one or more pre-determined fields of SL-CommResourcePoolV2X object describing R_{S}, and “|” being a concatenation operator;
wherein X_{UE}=K_{S} and Xₐᵤₜₕ={X_{UE},R_{S}}; and
wherein a verification whether the communication apparatus is authorised to allocate resources from the resource pool R_{S} comprises determining whether R_{S1} is part of R_{S} and whether digest(R_{S}.fields|X_{UE}) is the same as the resource information X_{S} that is associated with resource pool R_{S}.

6. The communication apparatus according to claim 1, wherein the receiver is configured to receive X_{S} from the base station, wherein X_{S} is a public key K_{pub} of a asymmetric key-pair {K_{pub},Kₚᵣᵥ}, Kₚᵣᵥ being a private key;
wherein X_{UE}=enc(digest(R_{S}.fields),Kₚᵣᵥ), “digest(m)” being a cryptographic digest/checksum of octet string m and “enc(m,k)” being an encryption of an octet string m using key k;
wherein Xₐᵤₜₕ={X_{UE},R_{S}}; and
wherein a verification whether the communication apparatus is authorised to allocate resources from the resource pool R_{S} comprises determining whether R_{S1} is part of R_{S} and whether dec(X_{UE},X_{S})=digest(R_{S}.fields), “dec(m,k)” being a decryption of an octet string m using key k and “R_{S}.fields” being a concatenation of one or more pre-determined fields of SL-CommResourcePoolV2X object describing resource pool R_{S}.

7. The communication apparatus according to claim 1, wherein the receiver is configured to receive X_{S} from the base station, wherein X_{S} is a public key K_{pub} of a asymmetric key-pair {K_{pub},Kₚᵣᵥ}, Kₚᵣᵥ being a private key;
wherein Xₐᵤₜₕ=enc(digest(R_{S}.fields),Kₚᵣᵥ), “digest(m)” being a cryptographic digest/checksum of octet string m and “enc(m,k)” being an encryption of an octet string m using key k; and
wherein a verification whether the communication apparatus is authorised to allocate resources from the resource pool R_{S} comprises determining whether dec(Xₐᵤₜₕ,X_{S})=digest(R_{S}.fields), “dec(m,k)” being a decryption of an octet string m using key k and “R_{S}.fields” being a concatenation of one or more pre-determined fields of SL-CommResourcePoolV2X object describing R_{S}.

8. A target communication apparatus, comprising:
a receiver, which in operation, receives a resource information X_{S} from a base station, as well as an authorisation information Xₐᵤₜₕ nd an allocated resource R_{S1} from a communication apparatus; and
circuitry, which in operation, determines whether or not to utilise the allocated resource R_{S1} based on a verification with the resource information X_{S} and authorisation information Xₐᵤₜₕ.

9. The target communication apparatus according to claim 8, wherein the receiver is configured to receive the resource information X_{S} from the base station via a broadcast.

10. The target communication apparatus according to claim 9, wherein the receiver is configured to receive the resource information X_{S}=digest(X_{UE}) from the base station, “digest(m)” being a cryptographic digest/checksum of octet string m;
wherein the receiver is configured to receive the authorisation information Xₐᵤₜₕ=X_{UE} from the communication apparatus; and
wherein the verification comprises checking if digest(Xₐᵤₜₕ)=X_{S}.

11. The target communication apparatus according to claim 8, wherein the receiver is configured to receive a list of {R_{S},X_{S}}ᵢ pairs from the base station, “R_{S}” being a resource pool of the allocated resource R_{S1}, wherein X_{S}=digest(R_{S}.fields|K_{S}) for a specific K_{S}, “digest(m)” being a cryptographic digest/checksum of octet string m, “R_{S}.fields” being a concatenation of one or more pre-determined fields of SL-CommResourcePoolV2X object describing R_{S}, and “|” being the concatenation operator;
wherein X_{UE}=K_{S} and Xₐᵤₜₕ={X_{UE},R_{S}}; and
wherein the verification comprises determining whether R_{S1} is part of R_{S} and whether digest(R_{S}.fields|X_{UE}) is the same as the broadcasted X_{S}.

12. The target communication apparatus according to claim 8, wherein the receiver is configured to receive X_{S} from the base station, wherein X_{S} is a public key K_{pub} of a asymmetric key-pair {K_{pub},Kₚᵣᵥ}, Kₚᵣᵥ being a private key;
wherein X_{UE}E=enc(digest(R_{S}.fields),Kₚᵣᵥ), “digest(m)” being a cryptographic digest/checksum of octet string m, “enc(m,k)” being an encryption of an octet string m using key k and “R_{S}.fields” being a concatenation of one or more pre-determined fields of SL-CommResourcePoolV2X object describing resource pool R_{S} of the allocated resource R_{S1;}
wherein Xₐᵤₜₕ={X_{UE,}R_{S}}; and
wherein the verification comprises determining whether R_{S1} is part of R_{S} and whether dec(X_{UE},X_{S})=digest(R_{S}.fields), “dec(m,k)” being a decryption of an octet string m using key k.

13. The target communication apparatus according to claim 8, wherein the receiver is configured to receive the resource information X_{S} from the base station, wherein X_{S} is a public key K_{pub} of a asymmetric key-pair {K_{pub},Kₚᵣᵥ}, Kₚᵣᵥ being a private key;
wherein Xₐᵤₜₕ=enc(digest(R_{S}.fields),Kₚᵣᵥ), “digest(m)” being a cryptographic digest/checksum of octet string m, “enc(m,k)” being an encryption of an octet string m using key k and “R_{S}.fields” being a concatenation of one or more pre-determined fields of SL-CommResourcePoolV2X object describing resource pool R_{S} of the allocated resource R_{S1}; and
wherein the verification comprises determining whether dec(Xₐᵤₜₕ,X_{S})=digest(R_{S}.fields), “dec(m,k)” being a decryption of an octet string m using key k.

14. The target communication apparatus according to claim 8, wherein the circuitry is further configured to perform the verification, or wherein the verification is performed by an external entity.

15. A communication method, comprising:
receiving a resource information X_{S} from a base station, as well as an authorisation information Xₐᵤₜₕ and an allocated resource R_{S1} from a communication apparatus; and
determining whether or not to utilise the allocated resource R_{S1} based on a verification with the resource information X_{S} and authorisation information Xₐᵤₜₕ.
